(19) United States
(12) Patent Application Publication
(10) Pub. No.: US 2002/0159330 A1
(43) Pub. Date: Oct. 31, 2002

(54) Electrical power from road seismic energy

(76) Inventor: Lee Moore, Castle Rock, CO (US)

Correspondence Address: Lee Moore, 7469 Shoreham Drive, Castle Rock, CO, 80104, US

(21) Appl. No.: 09/845,122

(22) Filed: Apr. 30, 2001

(51) Int. Cl. G01V 1/00

(52) U.S. Cl. 367/14

(57) ABSTRACT

The invention is titled Electrical Power from Road Seismic Energy. The invention consists of key concepts and proposed procedures to provide an environmentally friendly alternative source of electrical power. The invention is a description of methodology for producing electrical energy by the placement of transducers near and underneath highways. The seismic energy generated by passing traffic excites the transducers and the output of multiple transducers is combined to produce economically useful amounts of electrical power. The specific implementation of the invention is a battery charger that would also be used as the inventor's tests harness to evaluate the economics of the invention. The amount of potential energy generated by passing traffic on a highway is not generally appreciated. An analogy would be a car passing over a pontoon bridge, the pontoons rising and lowering in the water and generating waves in the water. The road seismic energy generated is greatly diminished in a relatively short distance away from the highway, and the invention is meant to capture this energy before it is diminished. The invention specifies a method of avoiding out-of-phase summation of the electrical power from multiple transducers. The invention discusses the need to match the natural frequency of the velocity transducers to the apparent seismic frequency at a particular location.

### CROSS REFERENCE TO RELATED APPLICATIONS (IF ANY)

There are no related applications.

### STATEMENT OF FEDERALLY SPONSORED RESEARCH/DEVELOPMENT (IF ANY)

The inventor submitted a pre-proposal for funding to the United States Department of Energy, Office of Industrial Technologies, but the DOE-OIT has discouraged the inventor from applying for funding

### REFERENCE TO A MICROFICHE APPENDIX (IF ANY)

There is no micro-fiche appendix.

### BACKGROUND OF THE INVENTION

The inventor is a professional geophysicist. The inventor was initially speculating on the feasibility for generating usable amounts of electrical power from naturally occurring wave energy in the oceans. These thoughts then turned to consider the high-energy seismic noise waves the inventor had encountered in other geophysical situations. The inventor recognized that road traffic generated very significant seismic waves that completely over-powered the geophysical detectors placed near busy highways. The inventor recognized that these seismic waves were of amplitude sufficient to provide usable amounts of electrical power if a method of converting the energy to electrical power could be invented.

### BRIEF SUMMARY OF THE INVENTION

The invention is the idea that useful electric power can be produced by the emplacement of either velocity sensitive and/or pressure sensitive transducers near highways. These velocity sensitive or pressure sensitive transducers would necessarily need to be placed singularly or in small or large numbers near or underneath the road-way, or both near and underneath the roadway. Multiple transducers would need to be connected in such a way as to minimize destructive interference between the transducers. The output electrical power could be either direct current or alternating current, and of an amount large enough to be sold to electric utility companies or small enough to be used local to the road to charge electric batteries.

The specific drawings presented with the application are for an arrangement of transducers used to charge batteries.

### BRIEF DESCRIPTION OF THE SEVERAL VIEWS OF THE DRAWING (IF ANY)

There is an electrical circuit diagram of a possible implementation of the invention included in the text of section (j) below. This possible implementation is a battery charger.

### DETAILED DESCRIPTION OF THE INVENTION

Electrical Power from Road Seismic Energy

1. Description of Road Seismic Energy

The inventor is a professional geophysicist. In the course of the inventor's career in exploration geophysics, there were certain situations where natural and man-made seismic interference energy completely obscured the exploration seismic signals that the author was attempting to record. The two major instances are wave energy in the oceans and road noise on land. The energy of the oceans waves are generally appreciated because of the visual reality of ships being tossed around by ocean waves.

The concept that road traffic produces high energy seismic waves is not generally appreciated. The inventor needs to discuss these road seismic waves, their strength, and their transmission.

How much energy is contained in seismic waves from traffic? Let us consider the simple case of a car weighing an estimated 800 kgs. traveling at a speed of 100 kms/hr.

[image]

When the car is at point A, it exerts a force of 800 kilograms on the road surface at point A. At the instance when the car is at point A, the compression force is 800 kilograms. The car passes off point A along the roadway, and the 800 kilograms force is removed, and the road surface is no longer under pressure. At point A plus an incremental distance x, the car compresses the roadbed with an 800 kilograms force at the location A+x at a time 0+x/V. The moving car generates a seismic wave with maximum peak amplitude of 800 kilograms at the road surface. The inventor's concept is that the seismic wave oscillates at point A as it dissipates. An analogy would be a car passing over a pontoon bridge, the pontoons rising and lowering in the water and generating waves in the water.

This seismic wave immediately begins to dissipate through three partially understood physical processes as it travels away from point A.

First, the wave spreads outward from each point of contact of the car with the road surface. This process is known as spherical divergence, and the wave amplitude at a particular distance is a function of how far the wave-front has traveled away from the originating point on the road surface. Second, the compression-rarefaction process by which the wave travels involves small movement of earth molecules and generates friction losses. Third, the seismic wave from point A and point A+x destructively or constructively interfere. How much destructive or constructive interference occurs is a function of geometry and frequency. For illustration, at a vehicle velocity of 100 kms per hour, the car travels 27.77 meters in 1 second. This is the natural wavelength where seismic waves from A and A+x would constructively interfere, i.e. where the initial compression from A+x would add to an oscillatory compression from point A. (See the discussion of natural oscillation in section 4.1 in this section). The wavelength 13.888 meters would destructively interfere, i.e. where the initial compression from point A+x would align with either the initial or the second rarefaction of point A. The seismic wave produced by car A would also constructively interfere and destructively interfere with the seismic wave generated by a vehicle at location B.

The process of constructive and destructive interference combined with spherical spreading is much more complicated than the simple two-point model described above. There is considerable energy generated by the movement of vehicles on roads. The total energy available is enormous when all vehicles on the roads at one time are considered. This energy is short-lived, but can be effectively captured by the method described in this patent application

2. Velocity and Pressure Transducers

There are two types of transducers (sensors) used in geophysical exploration to convert seismic waves to electrical signals. These are velocity sensitive and pressure sensitive transducers. The output voltage amplitude of single geophysical sensors is quite small and probably not individually large enough to be economically useful. Collectively the output voltage from individual sensors can be summed together to produce useful levels of electrical energy. The inventor also claims that the output of the velocity transducers can be greatly increased by removing the dampening resistor, matching the natural frequency of the velocity transducer to the dominant frequency of the seismic energy, and maintaining an interior vacuum inside the case of the velocity transducer.

The types of transducers used would be influenced by cost. The type of transducers used would also be influenced by the location of their emplacement.

Velocity sensitive transducers consist of a coil of conductors fixed to a case surrounding a magnet suspended by a spring. When the ground moves, the coil will move relative to the magnet generating an electrical current, elongating the suspending spring that would cause the coil to recover and generating electrical current during the recovery. The coil would naturally oscillate with diminishing amplitude, and generate electrical current as it oscillated. The natural frequency of the velocity transducer is determined by the stiffness coefficient of the suspending spring and the mass of the suspended magnet core. The natural frequency is that frequency at which the spring would oscillate after being subject to a single pulse. The inventor would try to specify a suitable spring coefficient and suspended mass so as to match the natural frequency of the electromagnetic transducer to the dominant frequency of the road seismic wave. If this desired matching of frequencies were accomplished, then the electric power output from the transducer would be maximized.

Velocity sensitive transducers have mechanical parts that move. These transducers would require occasional replacement, and would not be placed in an inaccessible location, such as under the road surface. Velocity sensitive transducers will respond to both pressure waves and shear waves.

Pressure sensitive transducers are solid state transducers that produce electric current in response to changes in confining pressure. The term for this type of material is piezoelectric materials. The common naturally occurring material used is quartz crystals. The inventor has heard of, but has no further knowledge of, man-made ceramic materials having piezoelectric capability. In geophysics, piezoelectric transducers are used on geophysical surveys where the pressure transducer is placed in water. Pressure sensitive transducers in water will respond to only pressure waves.

2.1 Geometry of Placement of Transducers

The inventor suggests that blankets of pressure sensitive transducers could be placed as single or multiple layers under the roadway during the infrequent times when the road surface has been taken up for replacement. The velocity sensitive transducers could be emplaced to the side of the road; multiple transducers in a vertical drilled hole. The velocity sensitive transducers would be retrievable for replacement of critical parts. The velocity transducers would need to be emplaced absolutely vertical.

2.2 Connection of Transducers

The small amounts of electrical energy output from the individual transducers needs to be combined to provide economically useful amounts of electrical power. Each transducer will respond to seismic waves having different instantaneous phase and amplitude. The electrical output of each transducer would be somewhat or completely out of phase versus the electrical output of transducers at another location. The inventor claims as part of the invention that individual transducers or closely spaced groups of transducers would be connected to a DC bus through a diode bridge to convert the alternating current output from the transducers to DC current. In this way, the electrical output from multiple transducers would constructively sum.

3. Is the Invention Economically Feasible?

The invention has obvious environmental benefits. The invention will be almost invisible and have minimal visible pollution. The invention will produce electric energy without burning fossil fuels and adding greenhouse gases to the atmosphere. The inventor's primary motivation was environmental when beginning consideration of the possibility of using seismic waves for electrical energy.

The important costs of the invention will be capital costs involved in building the transducer grids along and under highways. Operating costs will be minimal.

The inventor requests a patent for his invention. It is the concern of the inventor and commercial investors whether methods and efficiencies can be developed to make the generation of electrical power from road seismic an economical process.

4. Specific Embodiment of the Invention

The inventor has designed a specific arrangement of velocity transducers designed to charge batteries. This arrangement of velocity transducers and connecting cables would also be the measurement test harness used by the inventor to further investigate the commercial feasibility of using road seismic energy as a source of electrical power.

The proposed battery charger would be used to ‘trickle charge’ batteries at the side of a motorway and might have commercial applications providing a source of electrical power for motorway warning signs.

Diagram 1

Roadside Battery Charger consisting of eighteen velocity transducers connected in three strings of six velocity transducers each.

[image]

The battery to be charged would be connected between the positive and negative leads.

4.1 Natural Oscillating Frequency

The individual velocity transducers are specified to have a natural oscillating frequency equal to the peak frequency of the road seismic waves at a particular point. The natural period depends upon the mass and the restoring force of the spring mechanism (M. B. Dobrin and C. H. Savit, Introduction to Geophysical Prospecting, 4^{th} edition, 1988, McGraw-Hill).

The natural period T is dependent on the suspended mass m and the spring stiffness coefficient k of the spring. The stiffness coefficient k is the proportionality constant of the force on the spring and the elongation attributable to the force.

T=2π(m/k)^{½}

The natural frequency is the reciprocal of the period and the relation is

f=1/(2π(m/k)½)

Measurements should be taken of the dominant frequency of the road seismic noise at a particular roadside location and a velocity transducer with a natural frequency matching the dominant frequency of the road seismic noise should be used.

The reason for adjusting the stiffness coefficient so that the natural oscillating frequency matches the dominant frequency of the road seismic energy is to maximize the output from the electromagnetic velocity transducers. The alternative to adjusting the spring stiffness coefficient is to adjust the mass of the suspended magnet core of the velocity transducer. This suggests that larger and smaller magnets would be used with appropriate suspending springs to achieve a matching of the natural frequency of the velocity transducer to the dominate frequency of road seismic energy.

1. The inventor is claiming patent protection for the production of usable electric power from road seismic energy.
Road seismic energy is defined as the compression or shear waves generated in the road surface material by the passage of traffic along a road or highway. These compression or shear seismic waves are transmitted through the road material and surrounding earth material until their amplitude has diminished to the background seismic level because of destructive seismic interference, losses from spherical divergence, and losses from friction. The inventor is claiming that his invention covers the production of usable electric power in all cases where the road seismic wave(s) are distinguishable from the background seismic level.
Usable electric power is defined by the inventor as either direct or alternating current produced which is of suitable amplitude to perform an economic function. The lower boundary of suitable amplitude is the production of enough direct current to charge a battery or power a digital logic circuit. The inventor envisions that the invention will allow the construction of large projects with the intent of producing electric power for sale to electric utilities.

2. The inventor is claiming patent protection on the use of rectifier circuits of diodes and resistors for connecting together of individual or groups of transducers. This invention feature is to minimize energy losses when the output electricity waveforms from these individual or groups of transducers are combined. Transducers in different locations will output electrical waveforms of different phase that will destructively combine without some method of correction.

3. The inventor is claiming patent protection on the matching of the natural frequency of electromagnetic velocity transducers to the dominant frequency of the road seismic energy by means of specifying specific values of spring stiffness coefficients or the suspended mass. This invention feature is to allow constructive harmonic oscillations to sum and produce considerably greater electrical output.
